(19) United States
(12) Patent Application Publication
(10) Pub. No.: US 2026/0107073 A1
(43) Pub. Date: Apr. 16, 2026

(54) IMAGE SENSOR INCLUDING GAIN CONTROL CIRCUIT AND OPERATING METHOD OF THE IMAGE SENSOR

(71) Applicant: Samsung Electronics Co., Ltd., Suwon-si (KR)

(72) Inventors: Junoh Kim, Suwon-si (KR); Haewon Lee, Suwon-si (KR)

(73) Assignee: Samsung Electronics Co., Ltd., Suwon-si (KR)

(21) Appl. No.: 19/355,430

(22) Filed: Oct. 10, 2025

(30) Foreign Application Priority Data
Oct. 14, 2024 (KR) 10-2024-0139724

(51) Int. Cl. H04N 25/77; H04N 25/709

(52) U.S. Cl. CPC H04N 25/77; H04N 25/709

(57) ABSTRACT

An image sensor includes a reference generation circuit and a plurality of pixels. Each pixel includes a floating diffusion node configured to accumulate charge generated by a photodiode associated with a pixel of the image sensor. A driving transistor generates a pixel output voltage based on a voltage at the floating diffusion node. A selection transistor electrically connected to the driving transistor switches the pixel output voltage in response to a selection signal. The reference voltage generation circuit applies a reference voltage to one terminal of the first selection transistor.

### CROSS-REFERENCE TO RELATED APPLICATION

This application claims priority from Korean Patent Application No. 10-2024-0139724, filed on Oct. 14, 2024, in the Korean Intellectual Property Office, and all the benefits accruing therefrom under 35 U.S.C. § 119, the entire contents of which are hereby incorporated by reference.

### TECHNICAL FIELD

Apparatuses and methods consistent with some embodiments of the present disclosure relate to an image sensor, and more particularly, to an image sensor including a gain control circuit and operating methods thereof.

### BACKGROUND

Image sensors may convert optical signals to electrical signals. Image sensors are used not only in general consumer electronics, such as digital cameras, mobile phones, and portable camcorders, but are also used in cameras mounted on automobiles, security devices, and robots.

With advancements in computer and communication industries, there is an increase in demand for high performance image sensors in various fields. As the resolution of image sensors increases and pixel size decreases, image sensors having a wide dynamic range and good noise characteristics may be desirable for high-quality imaging.

### SUMMARY

Some embodiments consistent with the present disclosure provide an image sensor having a wide dynamic range and good noise characteristics.

Some embodiments consistent with the present disclosure provide an image sensor capable of controlling a voltage gain of a pixel voltage with respect to a floating diffusion voltage and an operating method of the image sensor.

In addition, the issues to be solved by the technical idea of the present disclosure are not limited to those mentioned above, and other issues may be clearly understood by those of ordinary skill in the art from the following descriptions.

Some embodiments consistent with the present disclosure provide an image sensor comprising a reference voltage generation circuit, and a plurality of pixels. A first pixel of the plurality of pixels comprises a first floating diffusion node configured to accumulate charge generated by a first photodiode associated with the first pixel, a first driving transistor configured to generate a first pixel output voltage based on a first voltage at the first floating diffusion node, and a first selection transistor electrically connected to the first driving transistor and configured to switch the first pixel output voltage in response to a first selection signal. The reference voltage generation circuit configured to apply a reference voltage to one terminal of the first selection transistor.

Some embodiments consistent with the present disclosure provide a method of operating an image sensor including a plurality of pixels. Each pixel of the plurality of pixels comprises a selection transistor. The method comprises receiving a gain control signal from an image processing device associated with the image sensor, adjusting a voltage gain of a pixel output voltage associated with a pixel of the plurality of pixels based on the gain control signal, and applying a reference voltage to the selection transistor included in each of the plurality of pixels.

Some embodiments consistent with the present disclosure provide an image sensor including a reference voltage generation circuit, a plurality of load transistors connected to a column output line, and a plurality of pixels connected to the column output line. Each of the plurality of pixels comprises a floating diffusion node configured to accumulate charge generated by a photodiode, a driving transistor configured to generate a pixel voltage according a voltage at the floating diffusion node, and a selection transistor electrically connected to the driving transistor and configured to switch an output of the pixel voltage in response to a selection signal. The reference voltage generation circuit is configured to apply a reference voltage to one terminal of the selection transistor.

### BRIEF DESCRIPTION OF THE DRAWINGS

The accompanying drawings are included to provide a further understanding of disclosed example embodiments, and are incorporated in and constitute a part of this specification. In the drawings:

FIG. 1A is a block diagram of an image processing system, consistent with some embodiments of the present disclosure.

FIG. 1B is a flowchart of an operating method of an image sensor, consistent with some embodiments of the present disclosure.

FIG. 2 is a block diagram of a configuration of the image sensor of FIG. 1A, consistent with some embodiments of the present disclosure.

FIG. 3 is a circuit diagram of a first pixel, a second pixel, and a gain control circuit, which are included in a pixel array of FIG. 2, consistent with some embodiments of the present disclosure.

FIG. 4 is a circuit diagram of a pixel included in the pixel array in FIG. 2, consistent with some embodiments of the present disclosure.

FIG. 5 is a circuit diagram of a first pixel and the gain control circuit, which are included in the pixel array in FIG. 2, consistent with some embodiments of the present disclosure.

FIGS. 6 through 10 are circuit diagram of example gain control circuits included in the pixel array in FIG. 2, consistent with some embodiments of the present disclosure.

FIG. 11 is a table of reference voltage information stored in an image sensor, consistent with some embodiments of the present disclosure.

FIG. 12 illustrates graphs for describing a voltage gain and a reference voltage in an image sensor, consistent with some embodiments of the present disclosure.

FIGS. 13A and 13B illustrate timing diagrams of signals input to a readout circuit in FIG. 2, and are diagrams for describing an operation of an analog-digital converter (ADC) in FIG. 2, consistent with some embodiments of the present disclosure.

### DETAILED DESCRIPTION

Example embodiments of the present disclosure will now be described more fully with reference to the accompanying drawings, in which example embodiments are shown.

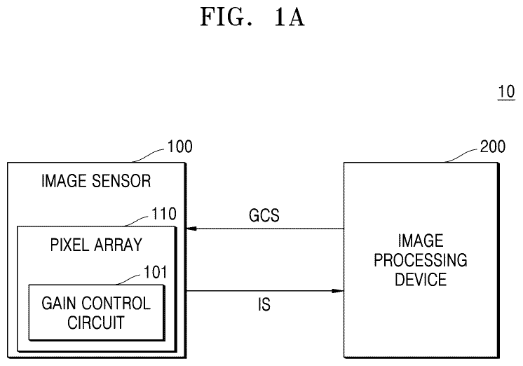

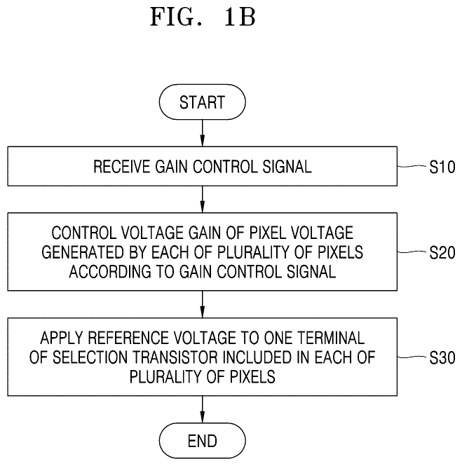

FIG. 1A is a block diagram of an image processing system 10 including an image sensor 100 and FIG. 1B illustrates a flowchart of an operating method of the image sensor 100, consistent with some embodiments of the present disclosure.

The image processing system 10 may be implemented by an electronic device which shoots an image, displays the shot image, or performs an operation based on the shot image. The image processing system 10 may be implemented as, for example, a personal computer (PC), an Internet of Things (IOT) device, or a portable electronic device. The portable electronic device may include a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, among other things. In addition, the image processing system 10 may be mounted on an electronic device, such as a drone and an advanced driver assistance system (ADAS), or on an electronic device equipped as a component in a vehicle, furniture, manufacturing facilities, doors, various measurement equipment, among other things.

Referring to FIG. 1A, image processing system 10 may include an image sensor 100 and an image processing device 200. The image processing system 10 may further include other components, such as a display and a user interface (both of which are not shown). The image processing device 200 or the image processing system 10 may be implemented as a system on chip (SoC). In some embodiments, the image processing system 10 or the image processing device 200 may include an application processor (AP) (not shown).

In some embodiments, image sensor 100 may be implemented as an image sensor chip or as a camera module. The image sensor 100 may be configured to convert an optical signal reflected by an object into an electrical signal, and generate and output image data IS based on the electrical signals.

The image sensor 100 may include a pixel array 110 including a plurality of pixels arranged in two dimensions. In addition, for example, the image sensor 100 may include a correlated double sampler sampling electrical signals that have been generated from optical signals by the pixel array 110, an analog-to-digital converter converting analog signals provided by correlated double samplers into digital signals, a latch outputting digital signals, a signal processing circuit, etc. The image sensor 100 may transmit image data via a mobile industry processor interface (MIPI) or via a camera serial interface (CSI).

The pixel array 110 may include a gain control circuit 101 for controlling a voltage gain of a pixel voltage generated by each of the plurality of pixels. The gain control circuit 101 may include a load transistor connected to a column output line from which the pixel voltage is output, and may control the voltage gain of the pixel voltage by changing characteristics of the load transistor connected to the column output line. For example, the gain control circuit 101 may include a plurality of load transistors, and may control the voltage gain of the pixel voltage by changing the load transistor connected to the column output line. In some embodiments, the gain control circuit 101 may control the voltage gain of the pixel voltage by changing the number of load transistors connected to the column output line.

For example, the image sensor 100 may lower the voltage gain relatively in a high illuminance environment, and increase the voltage gain relatively in a low illuminance environment. Therefore, in the low illuminance environment, the signal-to-noise ratio (SNR) characteristics in the low illuminance environment may be improved.

Referring to FIGS. 1A and 1B, in operation S10, the image sensor 100 may receive a gain control signal GCS from image processing device 200. The gain control signal GCS may include a signal provided to the image sensor 100 according to an external illuminance environment.

In operation S20, according to the gain control signal GCS, the image sensor 100 may control a voltage gain of a pixel voltage generated by each of the plurality of pixels.

In operation S30, the image sensor 100 may apply a reference voltage to one terminal of a selection transistor included in each of the plurality of pixels. The magnitude of the reference voltage may correspond to the magnitude of the voltage gain. In some embodiments, as the magnitude of the voltage gain increases, the magnitude of the reference voltage may increase as well.

For example, the image sensor 100 may store a table including information about the magnitude of the reference voltage with respect to the magnitude of the voltage gain. The image sensor 100 may apply the reference voltage to one terminal of the selection transistor included in each of the plurality of pixels, based on the table. Accordingly, the image sensor 100 may secure an operating range of the pixel in a high gain mode having a relatively high gain.

Referring back to FIG. 1A, the image processing device 200 may output the gain control signal GCS according to illuminance. In an embodiment, the image processing system 10 may include a sensor module, for example, at least one of a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. For example, image processing device 200 may obtain an illuminance value from the illuminance sensor, and generate the gain control signal GCS according to the illuminance value. Alternatively, in some embodiments, the image processing device 200 may also obtain the illuminance value from the image data IS provided by the image sensor 100.

The image processing device 200 may process the image data IS received from the image sensor 100. For example, the image processing device 200 may reduce noise in the image data IS, and perform an image signal processing process to improve image quality, such as gamma correction, color filter array interpolation, color matrix, color correction, or color enhancement.

In addition to the image processing operation described above, the image processing device 200 may perform an operation of converting the format of image data into a format of full image data of red color, green color, and blue color. In addition, the image processing device 200 may perform pre-processing, such as crosstalk correction and a despeckle operation on the image data IS, and may also further perform post-processing such as a sharpening operation on full image data. In addition, for example, the image processing device 200 may also further perform operations, such as auto dark level compensation (ADLC), bad pixel correction, and lens shading correction, on the image data IS.

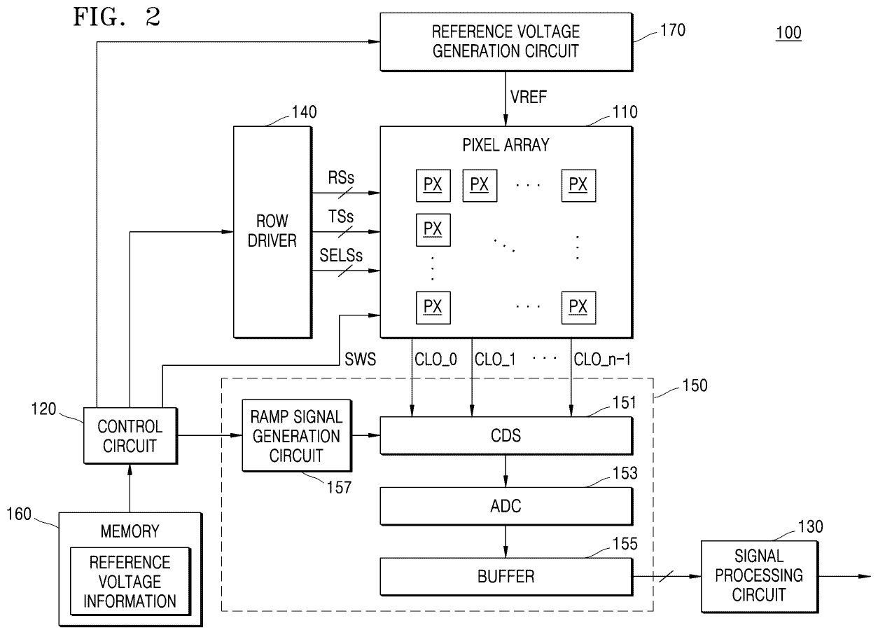

FIG. 2 is a block diagram of a configuration of the image sensor 100 of FIG. 1A, consistent with some embodiments of the present disclosure.

Referring to FIG. 2, the image sensor 100 may include a pixel array 110, a control circuit 120, a signal processing circuit 130, a row driver 140, and a readout circuit 150. The readout circuit 150 may include a correlated-double sampling (CDS) circuit 151, an analog-to-digital converter (ADC) 153, and a buffer 155. In addition, the image sensor 100 may include a memory 160 and a reference voltage generation circuit 170.

The pixel array 110 may convert an optical signal into an electrical signal, and include a plurality of pixels PX arranged in two dimensions. Each of the plurality of pixels PX may generate pixel voltages based on the intensity of sensed light. A pixel PX may be implemented as, for example, a photoelectric conversion device, such as a charge-coupled device (CCD), a complementary metal-oxide-semiconductor (CMOS), and/or as other various types of photoelectric conversion devices.

The pixel array 110 may include a color filter to sense various colors, and each of the plurality of pixels PX may sense a corresponding color. For example, the pixel array 110 may also have a Bayer pattern, or a tetra pattern (k=2) or nona pattern (k=3), in which a red color filter, a green color filter, and a blue color filter are arranged in a k×k matrix. Alternatively, for example, the pixel array 110 may also include at least one of a white color filter, a yellow color filter, a cyan color filter, or a magenta color filter.

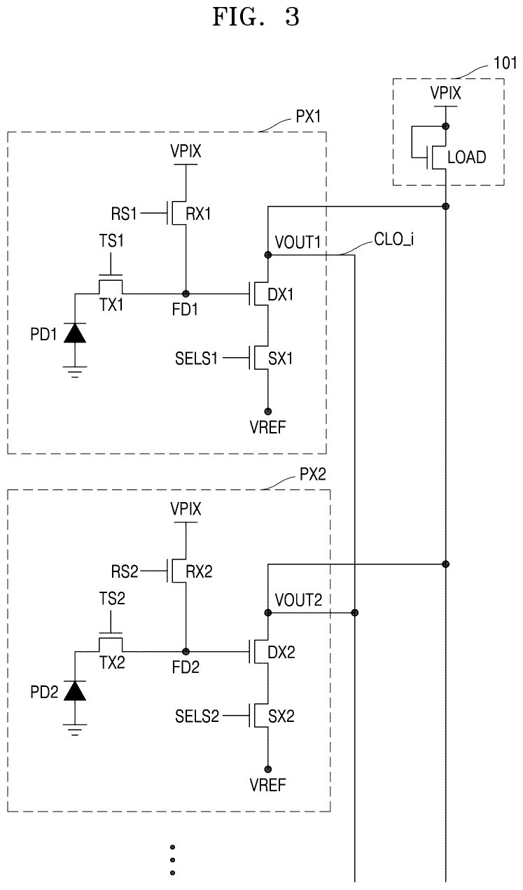

In some embodiments, each of the plurality of pixels PX may output the pixel voltage to the CDS circuit 151 via corresponding first through n^{th} column output lines CLO_0 through CLO_n-1. Description of the configuration of the pixel PX is given in detail with reference to FIGS. 3 through 5.

The pixel array 110 may further include the gain control circuit (for example, gain control circuit 101 of FIG. 1). The gain control circuit 101 may include the load transistor connected to a column output line (a corresponding column output line among the first through n^{th} column output lines CLO_0 through CLO_n-1) from which the pixel voltage is output, and by changing the characteristics of the load transistor connected to the column output line, gain control circuit 101 may control the voltage gain of the pixel voltage of the pixel PX with respect to a floating diffusion node voltage of the pixel PX.

In some embodiments, each of the plurality of pixels PX included in the pixel array 110 may include the gain control circuit 101. Alternatively, in some embodiments, one gain control circuit 101 may also be connected to one column output line (a corresponding column output line among the first through n^{th} column output lines CLO_0 through CLO_n-1).

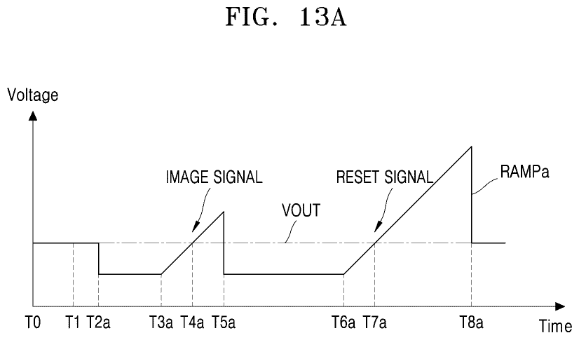

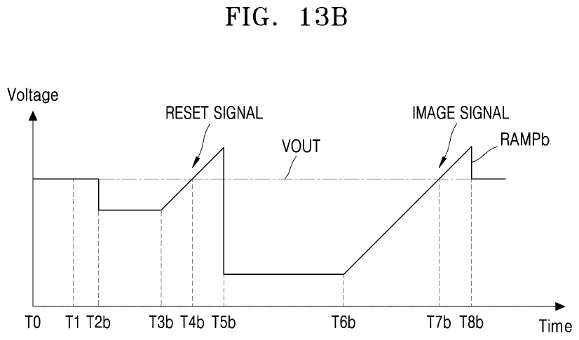

The CDS circuit 151 may sample and hold the pixel voltage provided by the pixel array 110. The CDS circuit 151 may double sample a level of a particular noise and a level according to the pixel voltage, and output a level corresponding to a difference between them. In addition, the CDS circuit 151 may receive ramp signals (for example, RAMPa in FIG. 13A and RAMPb in FIG. 13B) generated by a ramp signal generation circuit 157, compare them with each other, and output a comparison result. Description of the ramp signals RAMPa and RAMPb are provided in detail below with reference to FIGS. 13A and 13B.

In some embodiments, the ADC 153 may convert an analog signal corresponding to a level received from the CDS circuit 151 into a digital signal. The buffer 155 may latch the digital signal, and the latched digital signal may be sequentially output, as image data, to the signal processing circuit 130 or to the outside of the image sensor 100.

The control circuit 120 may control the row driver 140 so that the pixel array 110 absorbs light to accumulate charges, temporarily stores the accumulated charges, and outputs an electrical signal according to the stored charges to the outside of the pixel array 110. In addition, the control circuit 120 may control the readout circuit 150 to measure the level of the pixel voltage provided by the pixel array 110.

The signal processing circuit 130 may perform signal processing based on pixel voltages output by the plurality of pixels PX. For example, the signal processing circuit 130 may perform noise reduction process, gain control process, waveform shaping process, interpolation process, white balance process, gamma process, edge emphasization process, etc.

The row driver 140 may generate reset control signals RSs, transmission control signals TSs, and selection signals SELSs for controlling the pixel array 110, and provide the generated signals to the plurality of pixels PX. The row driver 140 may determine activation timing and deactivation timing of the reset control signals RSs, the transmission control signals TSs, and the selection signals SELSs provided to the pixels PX.

The memory 160 may store information necessary for an operation of the image sensor 100. The control circuit 120 may control the row driver 140 and the readout circuit 150, may control the reference voltage generation circuit 170, and may provide a switching signal SWS to the gain control circuit 101 included in the pixel array 110, by using the information stored in the memory 160.

In some embodiments, information about the magnitude of a reference voltage VREF with respect to the magnitude of the voltage gain of the pixel voltage output by the pixel array 110 may be stored in the memory 160. The control circuit 120 may provide, based on the information, the switching signal SWS for controlling the voltage gain to the pixel array 110, and may control the reference voltage generation circuit 170. For example, the memory 160 may store a table including information about the magnitude of the reference voltage and the magnitude of the voltage gain. The memory 160 may store the magnitude of the voltage gain and the magnitude of the reference voltage corresponding to each other.

The reference voltage generation circuit 170 may provide the reference voltage VREF to the pixel array 110. As the reference voltage VREF is applied to each of the plurality of pixels PX included in the pixel array 110, an operation range in which each of the plurality of pixels PX operates may be controlled. For example, in the low illuminance environment, the operation range of the pixel PX may be satisfied even when the voltage gain of the pixel voltage output by the pixel PX increases by providing the relatively high reference voltage VREF to each of the plurality of pixels PX.

In some embodiments, the control circuit 120 may provide the switching signal SWS so that all of the plurality of pixels PX included in the pixel array 110 have the same voltage gain, and the reference voltage VREF having the same magnitude may be provided to all of the plurality of pixels PX included in the pixel array 110. Alternatively, in some embodiments, while some pixels PX of the pixel array 110 may be controlled to have a first voltage gain and a first reference voltage is applied, other pixels PX of the pixel array 110 may be controlled to have a second voltage gain and a second reference voltage may also be applied.

In some embodiments, the image sensor 100 may be implemented as a single chip in a single layer. Alternatively, in some embodiments, the image sensor 100 may also include a stack-type image sensor including a plurality of layers. For example, the image sensor 100 may include a first layer on which the pixel array 110 is formed, and a second layer stacked under the first layer. The second layer may include at least some of the control circuit 120, the signal processing circuit 130, the row driver 140, the readout circuit 150, the memory 160, and the reference voltage generation circuit 170. Each of the first layer and the second layer may be implemented as a separate chip, or the first layer and the second layer may also be implemented as a single chip. Alternatively, in some embodiments, the image sensor 100 may include three or more layers.

FIG. 3 illustrates a circuit diagram of a first pixel PX1, a second pixel PX2, and a gain control circuit, which are included in the pixel array 110 in FIG. 2, consistent with some embodiments of the present disclosure. Although two pixels, that is, the first pixel PX1 and a second pixel PX2, are illustrated in FIG. 3, each of the pixels PX described with reference to FIG. 2 may be configured similar to circuits of the first pixel PX1 and the second pixel PX2 illustrated in FIG. 3.

Referring to FIG. 3, the first pixel PX1 may include a first photodiode PD1, a first transfer transistor TX1, a first selection transistor SX1, a first driving transistor DX1, and a first reset transistor RX1. The second pixel PX2 may include a second photodiode PD2, a second transfer transistor TX2, a second selection transistor SX2, a second driving transistor DX2, and a second reset transistor RX2. Each of the first pixel PX1 and the second pixel PX2 may output a first pixel voltage VOUT1 and a second pixel voltage VOUT2 via the same column output line CLO_i. The column output line CLO_i may include any one of the first through n^{th} column output line CLO_0 through CLO_n described with reference to FIG. 2.

The gain control circuit 101 may be connected to the column output line CLO_i. The gain control circuit 101 may include a load transistor LOAD, and according to characteristics of the load transistor LOAD, the voltage gain of the first pixel voltage VOUT1 output by the first pixel PX1 connected to the column output line CLO_i and the voltage gain of the second pixel voltage VOUT2 output by the second pixel PX2 connected to the column output line CLO_i may vary.

In some embodiments, each of the first photodiode PD1 and the second photodiode PD2 may generate a light charge that varies according to the intensity of light. For example, each of the first photodiode PD1 and the second photodiode PD2 may include a P-N junction diode, which generates a charge, that is, a negative charge or an electron, and a positive charge or a hole, in proportion to the amount of incident light. Each of the first photodiode PD1 and the second photodiode PD2 may include an example of a photodiode, and may include at least one of a phototransistor, a photo gate, a pinned photodiode (PPD), or a combination thereof.

The first transfer transistor TX1 may transmit the light charge generated by the first photodiode PD1 to a first floating diffusion node FD1 according to a first transfer control signal TS1. In other words, as the first transfer transistor TX1 is turned on, light charges generated by the first photodiode PD1 may be accumulated and stored at the first floating diffusion node FD1. The second transfer transistor TX2 may transfer the light charge generated by a second photodiode PD2 to a second floating diffusion node FD2 according to a second transfer control signal TS2. In other words, as the second transfer transistor TX2 is turned on, light charges generated by the second photodiode PD2 may be accumulated and stored at the second floating diffusion node FD2. The first transfer control signal TS1 and the second transfer control signal TS2 may be included in the transmission control signals TSs in FIG. 2.

The first reset transistor RX1 may periodically reset charges accumulated at the first floating diffusion node FD1. When the first reset transistor RX1 is turned on according to a first reset control signal RS1, charges accumulated at the first floating diffusion node FD1 may be discharged, and the first floating diffusion node FD1 may be reset. The second reset transistor RX2 may periodically reset charges accumulated at the second floating diffusion node FD2. When the second reset transistor RX2 is turned on according to a second reset control signal RS2, charges accumulated at the second floating diffusion node FD2 may be discharged, and the second floating diffusion node FD2 may be reset. The first reset control signal RS1 and the second reset control signal RS2 may be included in the reset control signals RSs in FIG. 2.

The first driving transistor DX1 may be controlled according to the amount of light charges accumulated at the first floating diffusion node FD1, and the first pixel voltage VOUT1 may be changed. The second driving transistor DX2 may be controlled according to the amount of light charges accumulated at the second floating diffusion node FD2, and the second pixel voltage VOUT2 may vary. The first driving transistor DX1 and the load transistor LOAD of the gain control circuit 101 may operate as a common source amplifier, and in addition, the second driving transistor DX2 and the load transistor LOAD of the gain control circuit 101 may operate as a common source amplifier.

A voltage gain Aᵥ of the first pixel voltage VOUT1 with respect to a voltage of the first floating diffusion node FD1, or a voltage gain Aᵥ of the second pixel voltage VOUT2 with respect to a voltage of the second floating diffusion node FD2, may be calculated using Equation 1.

$${A}_{v} = - \frac{{g}_{m , LD}}{{g}_{m , cs}} = - \frac{\sqrt{2 {μ}_{n} {C}_{OX , LD} ( \frac{{W}_{LD}}{{L}_{LD}} ) {I}_{D}}}{\sqrt{2 {μ}_{n} {C}_{OX , CS} ( \frac{{W}_{CS}}{{L}_{CS}} ) {I}_{D}}} = - \frac{\sqrt{{C}_{OXn} ( \frac{{W}_{LD}}{{L}_{LD}} )}}{\sqrt{{C}_{OXp} ( \frac{{W}_{CS}}{{L}_{CS}} )}} \qquad [ Equation 1 ]$$

In this case, g_{m,LD} refers to transconductance of the load transistor LOAD, g_{m,cs} refers to transconductance of the first driving transistor DX1 or the second driving transistor DX2, μₙ refers to charge (electron) mobility. C_{OX,LD} refers to capacitance of an oxide layer of the load transistor LOAD, W_{LD} refers to a channel width of the load transistor LOAD, L_{LD} refers to a channel length of the load transistor LOAD, C_{OX,CS} refers to capacitance of the oxide layer of the first driving transistor DX1 or the second driving transistor DX2, W_{CS} refers to a channel width of the first driving transistor DX1 or the second driving transistor DX2, L_{CS} refers to a channel length of the first driving transistor DX1 or the second driving transistor DX2, and I_{D} refers to the magnitude of the current flowing through the load transistor LOAD (the magnitude of the current flowing through the first driving transistor DX1 or the second driving transistor DX2).

Accordingly, the voltage gain (Aᵥ) of the first pixel voltage VOUT1 with respect to the voltage of the first floating diffusion node FD1 or the voltage gain (Aᵥ) of the second pixel voltage VOUT2 with respect to the voltage of the second floating diffusion node FD2 may be determined according to the size of the load transistor LOAD and the size of the first driving transistor DX1 or the second driving transistor DX2. The gain control circuit 101 may control the voltage gain independently of the process, voltage, and temperature (PVT), by controlling the characteristics of the load transistor LOAD connected to the column output line CLO_i.

In the first selection transistor SX1, a drain terminal may be connected to a source terminal of the first driving transistor DX1, and the reference voltage VREF may be applied to the source terminal of first selection transistor SX1. The output of the first pixel voltage VOUT1 via the column output line CLO_i may be switched in response to a first selection signal SELS1. A drain terminal of the second selection transistor SX2 may be connected to a source terminal of the second driving transistor DX2, and the reference voltage VREF may be applied to the source terminal of second selection transistor SX2. The output of the second pixel voltage VOUT2 via the column output line CLO_i may be switched in response to a second selection signal SELS2. The first selection signal SELS1 and the second selection signal SELS2 may be included in the selection signals SELSs in FIG. 2.

As the reference voltage VREF is applied to one terminal of the first selection transistor SX1 and the reference voltage VREF is applied to one terminal of the second selection transistor SX2, the operation range of a pixel may be secured in a high gain mode having a relatively high gain. For example, in a low illuminance environment, by applying a relatively high reference voltage VREF, the operating ranges of the first pixel PX1 and the second pixel PX2 may be satisfied even when the voltage gain is increased.

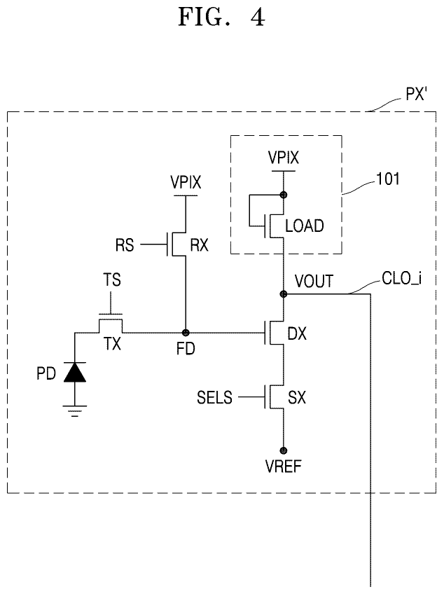

Reference is now made to FIG. 4, which illustrates a circuit diagram of the pixel PX′ included in the pixel array 110 in FIG. 2, consistent with some embodiments of the present disclosure. The pixel PX′ in FIG. 4 may correspond to each of the plurality of pixels PX illustrated in FIG. 2.

Referring to FIG. 4, the pixel PX′ may include a photodiode PD, a transmission transistor TX, a selection transistor SX, a driving transistor DX, a reset transistor RX, and the gain control circuit 101. In other words, compared to the first pixel PX1 and the second pixel PX2 in FIG. 3, the pixel PX′ in FIG. 4 may include the gain control circuit 101 therein.

The pixel PX′ may output the pixel voltage VOUT via the column output line CLO_i. The gain control circuit 101 may be connected to the column output line CLO_i, may include the load transistor LOAD, and according to the characteristics of the load transistor LOAD, the voltage gain of the pixel voltage VOUT output to the column output line CLO_i with respect to the voltage of the floating diffusion node FD may vary.

Descriptions of the photodiode PD, the transfer transistor TX, the selection transistor SX, the driving transistor DX, and the reset transistor RX may be similarly applied to the descriptions of the first photodiode PD1, the first transfer transistor TX1, the first selection transistor SX1, the first driving transistor DX1, and the first reset transistor RX1 in FIG. 3, respectively. The transfer transistor TX may transmit the light charge generated by the photodiode PD to the floating diffusion node FD, according to the transfer control signal TS, and the reset transistor RX may discharge the charges accumulated at the floating diffusion node FD according to the reset control signal RS. The driving transistor DX may be controlled according to the amount of light charges accumulated at the floating diffusion node FD, and accordingly, the pixel voltage VOUT may vary. The selection transistor SX may switch the output of the pixel voltage VOUT via the column output line CLO_i in response to the selection signal SELS.

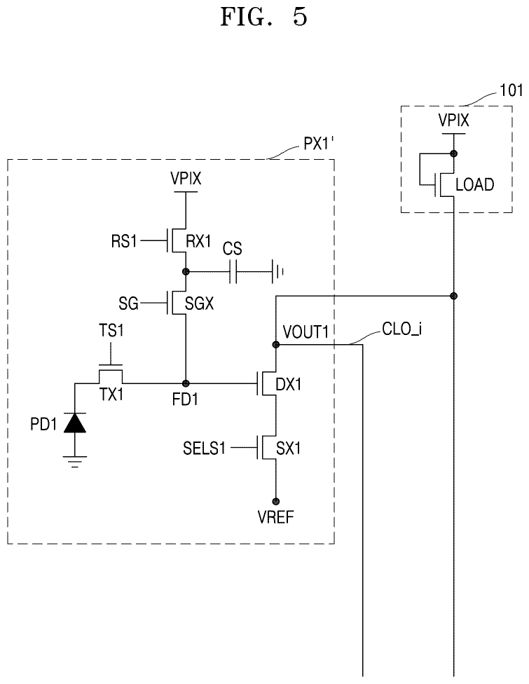

FIG. 5 shows a circuit diagram of a first pixel PX1′ and a gain control circuit, which are included in the pixel array in FIG. 2, consistent with some embodiments of the present disclosure. In the description with reference to FIG. 5, duplicate description of the same reference numerals given with reference to FIG. 3 are omitted. Descriptions of the first pixel PX1′ given with respect to FIG. 5 may also be applied to the other pixels PX illustrated in FIG. 2.

Referring to FIG. 5, the first pixel PX1′ may include the first photodiode PD1, the first transfer transistor TX1, the first selection transistor SX1, the first driving transistor DX1, and the first reset transistor RX1. In addition, the first pixel PX1′ may include a storage control transistor SGX and a capacitor CS.

The first reset transistor RX1 may reset the first floating diffusion node FD1 according to the first reset control signal RS1 provided by the row driver (for example, row driver 140 of FIG. 2) (for example, reset to a level of a power supply voltage VPIX). In addition, the first reset transistor RX1 may reset the capacitor CS according to the first reset control signal RS1 (for example, reset to the level of the power supply voltage VPIX). In other words, the first reset transistor RX1 may be turned on in response to the first reset control signal RS1 applied to a gate thereof, and may reset the first floating diffusion node FD1 or the capacitor CS based on the power voltage VPIX. For example, as the storage control transistor SGX is turned on together with the first reset transistor RX1 in response to a storage control signal SG received at the gate thereof, the power voltage VPIX may be applied to the first floating diffusion node FD1 and the first floating diffusion node FD1 may be reset.

The capacitor CS may include a passive device having a fixed or variable capacitance, or a capacitor formed or connected by a source/drain of the storage control transistor SGX, or a parasitic capacitor formed in another pixel (for example, the pixel PX in FIG. 2) which may be connected to the source/drain of the storage control transistor SGX.

Because the first photodiode PD1 may generate charges according to light intensity, the amount of charges generated by the first photodiode PD1 may vary depending on the shooting environment (low or high illumination) of the image. For example, in a high illuminance environment, the amount of charges generated by the first photodiode PD1 may reach full well capacity (FWC) of the first photodiode PD1, but in a low illuminance environment, it may not reach the FWC.

In some embodiments, charges accumulated at the first floating diffusion node FD1 may be converted into voltages of the first floating diffusion node FD1. A conversion gain (the unit of the conversion gain may be, for example, uV/e) may be determined by the capacitance of the first floating diffusion node FD1, and may be inversely proportional to the magnitude of the capacitance. When the capacitance of the first floating diffusion node FD1 increases, the conversion gain may decrease, and when the capacitance decreases, the conversion gain may increase.

The storage control transistor SGX may be turned on or off based on the storage control signal SG received at the gate thereof, and when the storage control transistor SGX is turned “on,” because the capacitor CS is connected to the first floating diffusion node FD1, and the first floating diffusion node FD1 has parasitic capacitance and capacitance due to the capacitor CS, the total capacitance may increase.

When the storage control transistor SGX is in an OFF state, the conversion gain may be higher than the conversion gain at the time when the storage control transistor SGX is in the ON state. When the storage control transistor SGX is in the OFF state, the OFF state may be referred to as a high conversion gain (HCG) mode, and when the storage control transistor SGX is in the ON state, the ON state may be referred to as a low conversion gain (LCG) mode.

In this manner, the first pixel PX1′ may operate in one of the HCG mode or the LCG mode according to the ON or OFF state of the storage control transistor SGX. The first pixel PX1′ may operate in the HCG mode in the low illuminance environment, and the low light amount sensing performance of the image sensor (for example, 100 of FIG. 2) may be improved. On the other hand, the first pixel PX1′ may operate in the LCG mode in the high illuminance environment, and because the capacitance of the first floating diffusion node FD1 of the first pixel PX1′ is large, the FWC may increase. Accordingly, the high light amount sensing performance of the image sensor 100 may be improved.

In this manner, by changing the capacitance of the first floating diffusion node FD1, the first pixel PX1′ may provide a dual conversion gain (DCG) and sense low luminance energy light and high luminance energy light, the dynamic range of the image sensor 100 may be expanded or increased. In some embodiments, the first pixel PX1′ may continuously operate in the HCG mode and the LCG mode in a readout period, and the image processing device (for example, image processing device 200 of FIG. 1A) receiving the image data (for example, IS in FIG. 1) from the image sensor 100 or the image sensor 100 may generate an image having a high dynamic range by combining a first image according to the HCG mode and a second image according to the LCG mode. The first pixel PX1′ providing the DCG described with reference to FIG. 5 may be an example, and the configuration of the first pixel PX1′ may be modified, as appropriate.

In some embodiments, the image sensor 100 may control a conversion gain by controlling capacitance at a floating diffusion node inside the pixel PX. Conversion gain, as used herein, refers to a ratio of a voltage of the floating diffusion node to charges accumulated at the floating diffusion node. In addition, the image sensor 100 may use the gain control circuit 101, and control the voltage gain, which is the ratio of the pixel voltage (for example, the first pixel voltage VOUT1) to the voltage at the floating diffusion node. Thus, the image sensor 100 may improve the SNR characteristics in a low illuminance environment.

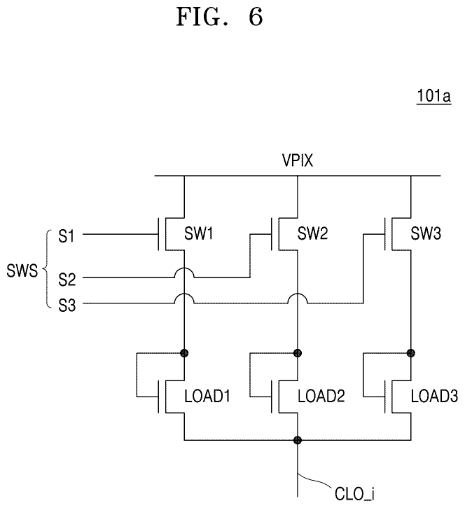

FIGS. 6 through 9 illustrate circuit diagrams of gain control circuits 101a through 101d, respectively, included in the pixel array 110 in FIG. 2, consistent with some embodiments of the present disclosure.

Referring to FIG. 6, the gain control circuit 101a may include a plurality of load transistors, for example, first load transistor LOAD1, second load transistor LOAD2, and third load transistor LOAD3, and may include a plurality of switches, for example, first switch SW1, second switch SW2, and third switch SW3, respectively corresponding to load transistors LOAD1, LOAD2 and LOAD3. Although FIG. 6 illustrates that three load transistors and three switches are included, the image sensor (for example, image sensor 100 of FIG. 1) is not limited thereto, and there may be fewer or more load transistors and switches included in the gain control circuit 101a, as appropriate.

In some embodiments, each of the load transistors (for example, LOAD1, LOAD2, and LOAD3) may be an N-type transistor, and a gate terminal may be connected to a drain terminal thereof. A source terminal of each load transistor LOAD1, LOAD2, and LOAD3 may be connected to the column output line CLO_i (for example, any one of the first through n^{th} column output lines CLO_1 through CLO_n in FIG. 2).

In some embodiments, each of the load transistors (for example, LOAD1, LOAD2, and LOAD3) may be connected to a corresponding switch SW1, SW2, and SW3, respectively. The first switch SW1 may be switched in response to the first signal S1 included in the switching signal SWS, and as the first switch SW1 is turned on, the first load transistor LOAD1 may operate as a load transistor of the gain control circuit 101a. The second switch SW2 may be switched in response to the second signal S2 included in the switching signal SWS, and as the second switch SW2 is turned on, the second load transistor LOAD2 may operate as a load transistor of the gain control circuit 101a. The third switch SW3 may be switched in response to the third signal S3 included in the switching signal SWS, and as the third switch SW3 is turned on, the third load transistor LOAD3 may operate as a load transistor of the gain control circuit 101a.

As previously described with reference to FIG. 3, a voltage gain of a pixel voltage may be determined according to transconductance of a driving transistor of a pixel and transconductance of a load transistor connected to the column output line CLO_i. Accordingly, the number of transistors driven as load transistors of the gain control circuit 101a may substantially vary according to the on/off state of the first through third switches SW1 through SW3 of the gain control circuit 101a, and the voltage gain of the pixel voltage output to the column output line CLO_i may vary.

In some embodiments, transistor characteristics of each of the load transistors (for example, LOAD1, LOAD2, and LOAD3), such as, but not limited to, the width of a channel, the length of the channel, and capacitance of the oxide layer, may be substantially similar. The voltage gain of the pixel voltage output to the column output line CLO_i may vary according to the number of transistors, to which the power voltage VPIX is applied to the drain terminals thereof, among the first through third load transistors LOAD1 through LOAD3. For example, when one of the switches SW1, SW2, or SW3 is turned on, the voltage gain may be defined as ‘1’, when two of the switches SW1, SW2, or SW3 are turned on, the voltage gain may be defined as ‘2’, and when three of the switches SW1, SW2, or SW3 are turned on, the voltage gain may be defined as ‘3’.

In some embodiments, transistor characteristics of each of the load transistors (for example, LOAD1, LOAD2, and LOAD3), such as, but not limited to, the width of a channel, the length of the channel, and capacitance of the oxide layer, may be different from each other. Accordingly, the voltage gain of the pixel voltage output to the column output line CLO_i may vary according to the type of switch to be turned on among the switches SW1, SW2, or SW3 or the number of switches.

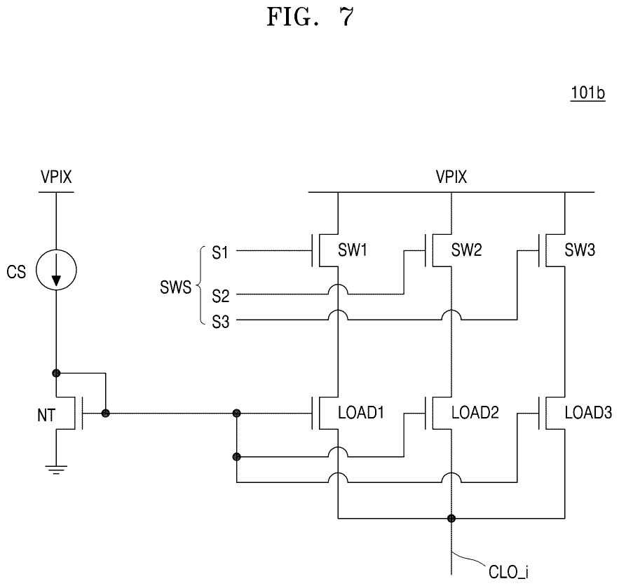

Referring to FIG. 7, the gain control circuit 101b may include a plurality of load transistors, for example, load transistors LOAD1, LOAD2, and LOAD3, and may include a plurality of switches SW1, SW2, and SW3, corresponding to the plurality of load transistors LOAD1, LOAD2, and LOAD3. In addition, the gain control circuit 101b may include a current source CS and an N-type transistor NT. The current source CS, the N-type transistor NT, and the load transistors LOAD1, LOAD2, and LOAD3 may have a current mirror circuit structure. In FIG. 7, all of the load transistors LOAD1, LOAD2, and LOAD3 are illustrated to constitute the current source CS, the N-type transistor NT, and the current mirror circuit structure, but the disclosure is not limited thereto. In some embodiments, each of the load transistors (for example, LOAD1, LOAD2, and LOAD3) may be connected to the current source CS and the N-type transistor NT which are separate from each other.

In comparison with the gain control circuit 101a described with reference to FIG. 6, because the gain control circuit 101b includes a current mirror circuit, a current flowing to a load transistor selected from among the load transistors LOAD1, LOAD2, and LOAD3, may be stable. In other words, even when the output of the power voltage VPIX is changed due to noise, the current may be stably provided to the load transistor.

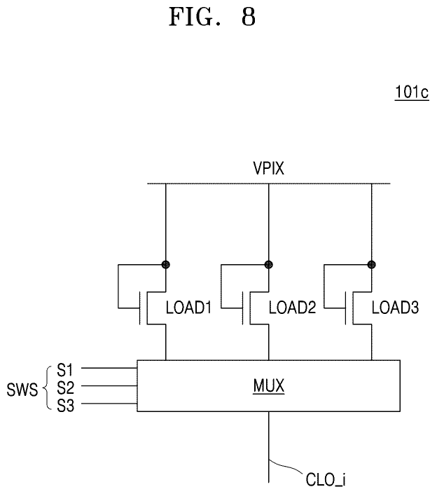

Referring to FIG. 8, the gain control circuit 101c may include a plurality of load transistors, for example, load transistors LOAD1, LOAD2, and LOAD3, and may include an analog multiplexer MUX connected to the plurality of load transistors LOAD1, LOAD2, and LOAD3.

In some embodiments, each of the load transistors (for example, LOAD1, LOAD2, and LOAD3) may be an N-type transistor, and a gate terminal may be connected to a drain terminal thereof. The power voltage VPIX may be applied to a drain terminal of each of the load transistors (for example, LOAD1, LOAD2, and LOAD3).

The analog multiplexer MUX may connect at least one load transistor selected from among the load transistors LOAD1, LOAD2, and LOAD3 to the column output line CLO_i according to the switching signal SWS. The selected load transistor may operate as a substantial load transistor of the gain control circuit 101c.

For example, the first load transistor LOAD1 may be connected to the column output line CLO_i according to the first signal S1 included in the switching signal SWS, the second load transistor LOAD2 may be connected to the column output line CLO_i according to the second signal S2 included in the switching signal SWS, and the third load transistor LOAD3 may be connected to the column output line CLO_i according to the third signal S3 included in the switching signal SWS.

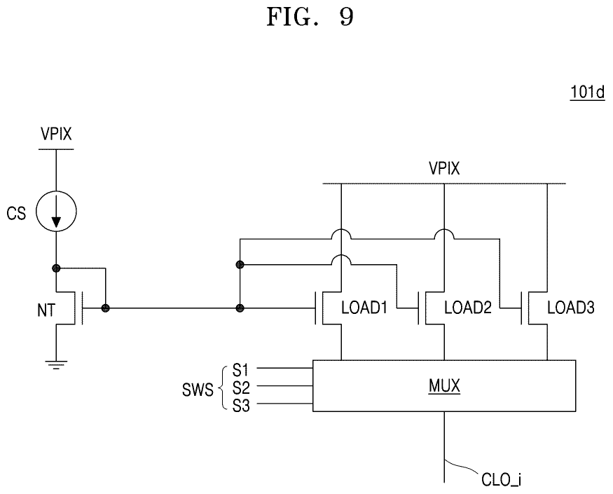

Referring to FIG. 9, the gain control circuit 101d may include a plurality of load transistors, for example, load transistors LOAD1, LOAD2, and LOAD3, and may include the analog multiplexer MUX connected to the plurality of load transistors. In addition, the gain control circuit 101d may include the current source CS and the N-type transistor NT. The current source CS, the N-type transistor NT, and the load transistors LOAD1, LOAD2, and LOAD3 may have a current mirror circuit structure.

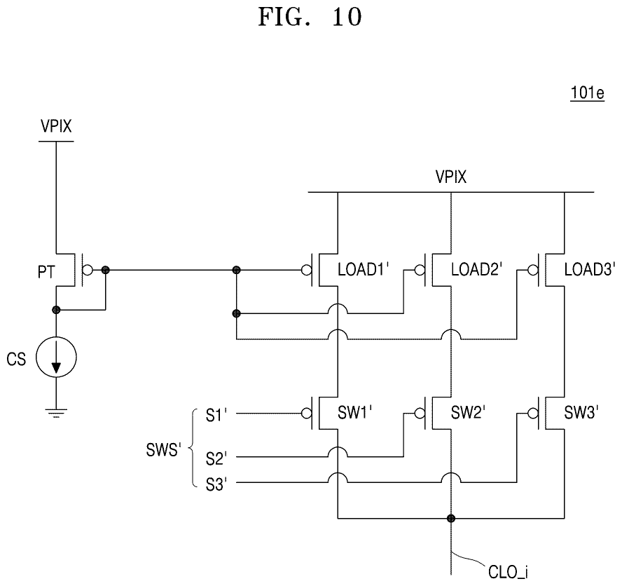

FIG. 10 is a circuit diagram of a gain control circuit 101e included in the pixel array 110 in FIG. 2, consistent with some embodiments of the present disclosure.

Referring to FIG. 10, the gain control circuit 101e may include a plurality of load transistors, for example, load transistors LOAD1′, LOAD2′, and LOAD3′, and a plurality of corresponding switches, for example, switches SW1′, SW2′, and SW3′, respectively. Each of the load transistors LOAD1′, LOAD2′, and LOAD3′ may be a P-type transistor.

In addition, the gain control circuit 101e may include the current source CS and a P-type transistor PT. Although FIG. 10 illustrates three load transistors and three switches, the image sensor (for example, image sensor 100 of FIG. 1) in this disclosure is not limited thereto, and there may be fewer or more load transistors and switches included in the gain control circuit 101e.

The current source CS, the P-type transistor PT, and the load transistors LOAD1′, LOAD2′, and LOAD3′ may have a current mirror circuit structure. In FIG. 10, all of the load transistors LOAD1′, LOAD2′, and LOAD3′ may form the current mirror circuit structure together with the current source CS and the P-type transistor PT, but the disclosure is not limited thereto. Each of the load transistors LOAD1′, LOAD2′, and LOAD3′ may be connected to a current source and a P-type transistor which are separate from each other.

In some embodiments, each of the load transistors LOAD1′, LOAD2′, and LOAD3′ may be connected to a corresponding switch among the switches SW1′, SW2 ‘, and SW3’. The first switch SW1′ may be switched in response to the first signal S1′ included in the switching signal SWS′, and as the first switch SW1′ is turned on, the first load transistor LOAD1′ may be connected to the column output line CLO_i (for example, any one of the first through n^{th} column output lines CLO_1 through CLO_n in FIG. 2), and may operate as a load transistor of the gain control circuit 101e. The second switch SW2′ may be switched in response to the second signal S2′ included in the switching signal SWS′, and as the second switch SW2′ is turned on, the second load transistor LOAD2′ may operate as a load transistor of the gain control circuit 101e. The third switch SW3′ may be switched in response to the third signal S3′ included in the switching signal SWS′, and as the third switch SW3′ is turned on, the third load transistor LOAD3′ may operate as a load transistor of the gain control circuit 101e.

The voltage gain Aᵥ₂ of the gain control circuit 101e may be calculated using Equation 2 below.

$${A}_{v 2} = - {g}_{mCS} {r}_{o} \qquad [ Equation 2 ]$$

In this case, g_{m,cs} refers to the transconductance of the driving transistor of the pixel connected to the gain control circuit 101e, and rₒ refers to the output resistance of the load transistor. Accordingly, the voltage gain of the pixel voltage may be determined, based on the transconductance of the driving transistor of the pixel and the output resistance of the load transistor connected to the column output line CLO_i. Accordingly, the number of transistors driven as load transistors of the gain control circuit 101e may vary substantially according to the on/off state of the switches SW1′, SW2′, and SW3′ of the gain control circuit 101e, and the voltage gain of the pixel voltage output to the column output line CLO_i may vary.

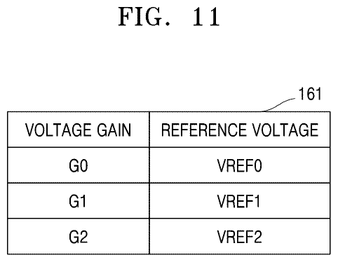

FIG. 11 shows an example of a table of reference voltage information stored in the image sensor 100, consistent with some embodiments of the present disclosure.

Referring to FIGS. 2 and 11, information about the magnitude of the reference voltage with respect to the magnitude of the voltage gain may be stored in the image sensor 100. Information about the magnitude of the reference voltage with respect to the magnitude of the voltage gain may be stored in the memory 160 of the image sensor 100. For example, a table 161 including information about the magnitude of the reference voltage with respect to the magnitude of the voltage gain may be stored in the memory 160, and the magnitude of the voltage gains G0, G1, and G2, and the magnitude of reference voltages VREF0, VREF1, and VERF2 may correspond to about 1:1. The table 161 may be stored so that as the magnitude of the voltage gains G0 through G2 increases, the magnitude of the corresponding reference voltages VREF0, VREF1, and VERF2 increases.

When the gain control signal (for example, GCS of FIG. 1) is received from the outside, for example, the image processing device 200 in FIG. 1, the image sensor 100 may determine the voltage gain and generate the switching signal SWS accordingly. In addition, the image sensor 100 may determine the magnitude of the reference voltage corresponding to the determined voltage gain, based on the table 161, and the reference voltage generation circuit 170 may provide the determined reference voltage VREF to the pixel array 110.

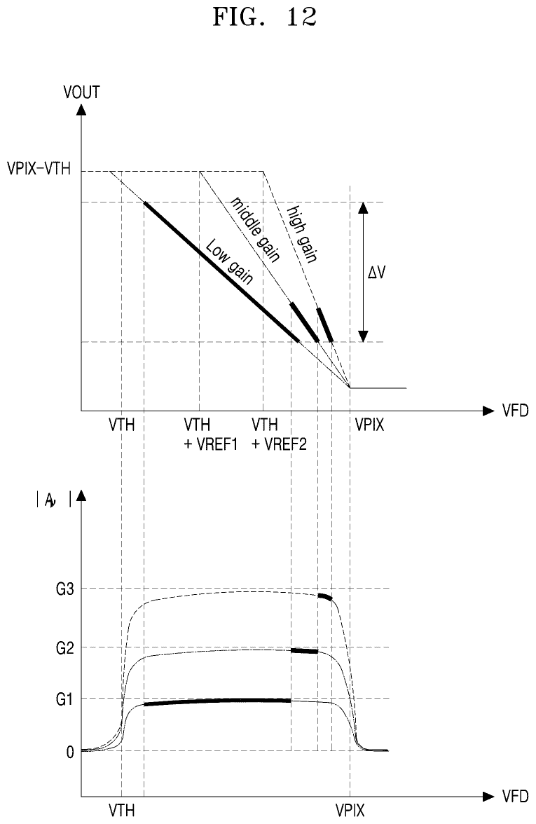

FIG. 12 illustrates examples of graphs for describing a voltage gain and a reference voltage in the image sensor 100, consistent with some embodiments of the present disclosure. FIG. 12 illustrates a graph of pixel voltage VOUT with respect to a floating diffusion node voltage VFD and a graph of the size of the voltage gain (Aᵥ) with respect to the floating diffusion node voltage VFD.

Referring to FIGS. 11 and 12, an image sensor may control the voltage gain according to illuminance. For example, the image sensor may operate in a low gain mode in a high illuminance environment, and the magnitude of the voltage gain (Aᵥ) may be G0 (for example, about 1). The image sensor may operate in a high gain mode in a low illuminance environment, and the magnitude of the voltage gain (Aᵥ) may be G1 (for example, about 3). The image sensor may operate in an intermediate gain mode in the other illuminance environment, and the magnitude of the voltage gain (Aᵥ) may be G1 (for example, about 2). The pixel voltage VOUT may be output within a range less than a value obtained by subtracting a threshold voltage VTH of the driving transistor from the power voltage VPIX. In the low gain mode, a reference voltage of VREF0 (for example, about 0) may be applied to a pixel, in the high gain mode, a reference voltage of VREF2 may be applied to a pixel, and in the intermediate gain mode, a reference voltage of VREF1 may be applied to a pixel.

As previously described, the driving transistor of a pixel and the load transistor of a gain control circuit may operate as a common source amplifier, and the voltage gain (Aᵥ) may be negative. Accordingly, the pixel voltage VOUT may be inverted with respect to the floating diffusion node voltage VFD. When the magnitude of the voltage gain Aᵥ is excessively large, an operation range of the floating diffusion node voltage VFD satisfying an operation range ΔV of the pixel voltage VOUT for an operation as a common source amplifier may be excessively narrow.

Accordingly, as the gain control circuit increases the magnitude of the voltage gain (Aᵥ), and also increases the magnitude of a reference voltage to applied to a pixel in a low illuminance state, the gain control circuit may shift the operation range of the floating diffusion node voltage VFD such that the floating diffusion node voltage VFD operates at a voltage close to the pixel voltage VPIX, which is an operation range of a photodiode in the low illuminance state. On the other hand, by reducing the magnitude of the voltage gain (Aᵥ) and reducing the magnitude of a reference voltage applied to a pixel in a high illuminance state, the gain control circuit may secure the operation range of the floating diffusion node voltage VFD in the high illuminance state.

FIGS. 13A and 13B illustrate example timing diagrams of signals input to the readout circuit 150 in FIG. 2, consistent with some embodiments of the present disclosure, and are diagrams for describing operations of the CDS circuit 151 and the ADC 153 in FIG. 2, respectively. FIGS. 13A and 13B are diagrams for describing the operations of the CDS circuit 151 and the ADC 153, when a reversed ramp signal RAMPa or RAMPb is received, as examples of the ramp signal in FIG. 2. In the image sensor according to some embodiments of the present disclosure, the voltage gain Aᵥ that is a ratio of the pixel voltage VOUT to the floating diffusion node voltage VFD may be negative, the pixel voltage VOUT may be inverted with respect to the floating diffusion node voltage VFD, and accordingly, the inverted ramp signal RAMPa or RAMPb may be generated.

Referring to FIGS. 2 and 13A, an interval from a time point T0 to a time point T1 may be defined as an auto zero interval, and an interval from the time point T1 to a time point T8a may be defined as a comparison operation interval. An auto zero signal may be activated from the time point T0 to the time point T1, and the CDS circuit 151 may be initialized in response to the auto zero signal.

After an offset is applied to the ramp signal RAMPa at a time point T2a for digital conversion of an image signal, the ramp signal RAMPa may increase from a time point T3a to a time point T5a. The counter of the ADC 153 may count a counting clock signal from the time point T3a to a time point T4a (a zero-crossing time point) at which the voltage level of the ramp signal RAMPa becomes the same as the voltage level of the pixel signal VOUT.

When the digital conversion of the image signal is completed, the offset may be applied again to the ramp signal RAMPa from the time point T5a to a time point Toa. To convert the reset signal into the digital signal, the ramp signal RAMPa may increase from the time point T6a to the time point T8a. The counter of the ADC 153 may count the counting clock signal from the time point Toa to a time point T7a at which the voltage level of the ramp signal RAMPa becomes the same as the voltage level of the pixel voltage VOUT.

Referring to FIGS. 2 and 13B, after a first offset is applied to the ramp signal RAMPb at a time point T2b for digital conversion of the reset signal, the ramp signal RAMPb may increase from a time point T3b to a time point T5b. The counter of the ADC 153 may count the counting clock signal from a time point T3b to a time point T4b at which the voltage level of the ramp signal RAMPb becomes the same as the voltage level of the pixel voltage VOUT.

When the digital conversion of the reset signal is completed, a second offset may be applied to the ramp signal RAMPb from the time point T5b to a time point T6b. In this case, the voltage level of the ramp signal RAMPb at the time point T5b at which a second offset is applied may be lower than the voltage level of the ramp signal RAMPb at the time point T2b at which the first offset is applied.

To convert the image signal into the digital signal, the ramp signal RAMPb may increase from the time point T6b to a time point T8b. The counter of the ADC 153 may count the counting clock signal from the time point T6b to a time point T7b at which the voltage level of the ramp signal RAMPb becomes the same as the voltage level of the pixel voltage VOUT.

Although exemplary embodiments have been described, the present disclosure should not be limited to these embodiments, but various changes and modifications can be made by one ordinary skilled in the art within the spirit and scope of the present disclosure as hereinafter claimed.

What is claimed is:

1. An image sensor, comprising:
a reference voltage generation circuit; and
a plurality of pixels, a first pixel of the plurality of pixels comprising:
a first floating diffusion node configured to accumulate charge generated by a first photodiode associated with the first pixel;
a first driving transistor configured to generate a first pixel output voltage based on a first voltage at the first floating diffusion node; and
a first selection transistor electrically connected to the first driving transistor and configured to switch the first pixel output voltage in response to a first selection signal,
wherein the reference voltage generation circuit configured to apply a reference voltage to one terminal of the first selection transistor.

2. The image sensor of claim 1, further comprising a second pixel of the plurality of pixels, the second pixel comprising:
a second floating diffusion node configured to accumulate charge generated by a second photodiode associated with the second pixel;
a second driving transistor configured to generate a second pixel output voltage based on a second voltage at the second floating diffusion node; and
a second selection transistor connected to the second driving transistor and configured to adjust the second pixel output voltage in response to a second selection signal, wherein the gain control circuit is electrically connected to the second driving transistor of the second pixel, and
the reference voltage generation circuit configured to apply the reference voltage to one terminal of the second selection transistor.

3. The image sensor of claim 2, further comprising a column output line configured to output the first pixel output voltage and the second pixel output voltage.

4. The image sensor of claim 1, wherein the gain control circuit further comprises a plurality of switches, and wherein each of the plurality of switches is connected to a corresponding load transistor of the plurality of load transistors.

5. The image sensor of claim 1, wherein each of the plurality of load transistors is an N-type transistor.

6. The image sensor of claim 1, wherein the gain control circuit further comprises an analog multiplexer connected to the plurality of load transistors.

7. The image sensor of claim 1, wherein the plurality of load transistors of the gain control circuit constitute a current mirror circuit.

8. The image sensor of claim 1, further comprising:
a control circuit configured to generate a switching signal, and
wherein the gain control circuit is configured to adjust the first voltage gain of the first pixel output voltage with respect to the first voltage at the first floating diffusion node in response to the switching signal generated by the control circuit.

9. The image sensor of claim 8, wherein the control circuit is configured to generate the switching signal in response to a gain control signal provide from the outside of the image sensor.

10. A method of operating an image sensor comprising a plurality of pixels, each pixel of the plurality of pixels comprising a selection transistor, the method comprising:
receiving a gain control signal from an image processing device associated with the image sensor;
adjusting a voltage gain of a pixel output voltage associated with a pixel of the plurality of pixels based on the gain control signal; and
applying a reference voltage to the selection transistor included in each of the plurality of pixels.

11. The method of claim 13, wherein the reference voltage is based on the voltage gain of the pixel output voltage.

12. The method of claim 14, wherein a magnitude of the applied reference voltage increases as a magnitude of the voltage gain increases.

13. The method of claim 13, wherein the adjusting the voltage gain comprises selecting a load transistor of a plurality of load transistors connected to a column output line, the column output line configured to output the pixel output voltage from each of the plurality of pixels.

14. The method of claim 16, wherein the adjusting the voltage gain further comprises adjusting a number of load transistors of the plurality of load transistors connected to the column output line.

15. The method of claim 16, wherein the adjusting the voltage gain further comprises adjusting a transconductance of the load transistor connected to the column output line.

16. An image sensor comprising:
a reference voltage generation circuit;
a plurality of load transistors connected to a column output line; and
a plurality of pixels connected to the column output line, each of the plurality of pixels comprising:
a floating diffusion node configured to accumulate charge generated by a photodiode;
a driving transistor configured to generate a pixel voltage according a voltage at the floating diffusion node; and
a selection transistor electrically connected to the driving transistor and configured to switch an output of the pixel voltage in response to a selection signal;
wherein the reference voltage generation circuit configured to apply a reference voltage to one terminal of the selection transistor.

17. The image sensor of claim 16, further comprising a plurality of switches respectively connected to corresponding load transistors among the plurality of load transistors.

18. The image sensor of claim 16, further comprising an analog multiplexer connected between the plurality of load transistors and the driving transistor.

19. The image sensor of claim 16, wherein the plurality of load transistors constitute a current mirror circuit.

20. The image sensor of claim 16, wherein a power voltage is applied to a gate of each of the plurality of load transistors.
